(19) United States
(12) Patent Application Publication
(10) Pub. No.: US 2025/0124914 A1
(43) Pub. Date: Apr. 17, 2025

(54) SPEECH RECOGNIZER BASED ON SHARED AND EXCLUSIVE ATTRIBUTES, AND SYSTEM AND METHOD FOR TRAINING THE SAME

(71) Applicant: ELECTRONICS AND TELECOMMUNICATIONS RESEARCH INSTITUTE, Daejeon (KR)

(72) Inventors: Byung Ok Kang, Daejeon (KR); Yoonhyung Kim, Daejeon (KR); Hwajeon Song, Daejeon (KR); HOON CHUNG, Daejeon (KR)

(21) Appl. No.: 18/734,064

(22) Filed: Jun. 5, 2024

(30) Foreign Application Priority Data
Oct. 12, 2023 (KR) 10-2023-0135527

(51) Int. Cl. G10L 15/06

(52) U.S. Cl. CPC G10L 15/063

(57) ABSTRACT

Provided is a method of training a speech recognizer based on shared and exclusive attributes. The method includes: inputting a parallel speech corpus constituting a labeled speech corpus and a non-parallel speech corpus into a speech encoder constituting a speech recognizer; outputting a representation vector representing training speech as an output of the speech encoder; inputting a parallel text corpus constituting the labeled speech corpus and a non-parallel text corpus into a text encoder; outputting a representation vector representing text as an output of the text encoder; and receiving and decoding, by a decoder, each of the representation vectors of the speech encoder and the text encoder.

### CROSS-REFERENCE TO RELATED APPLICATION

This application claims priority under 35 U.S.C. § 119 to Korean Patent Application No. 10-2023-0135527, filed on Oct. 12, 2023, in the Korean Intellectual Property Office, the disclosure of which is incorporated herein by reference in its entirety.

### BACKGROUND

### 1. Field of the Invention

The present invention relates to a speech recognizer based on shared and exclusive attributes, and a system and method for training the same.

### 2. Description of Related Art

In the field of conventional speech recognition, representation learning-based pre-trained models using large-scale speech data, such as Wav2vec 2.0 and HuBERT, have emerged as a major research topic. The models exhibit high performance in various tasks related to speech recognition, bringing innovative changes to existing speech processing technologies.

Models such as Wav2vec 2.0 and HuBERT have been developed focusing on pre-training of speech data. The models may be primarily trained based on speech data, and enable effective extraction of characteristics, pronunciation, intonation, and the like of speech, and thus may improve speech recognition performance. Additionally, these models may, with unlabeled speech data, perform pre-training without labels for speech recognition tasks, enabling automated feature extraction and transfer learning. In addition, the pre-trained model may be effectively transferred to various speech processing tasks, enabling utilization thereof in various application fields, such as speech recognition, speech synthesis, and speech emotion analysis.

However, most conventional technologies are trained focusing only on speech data, and have a limitation in effectively utilizing text data. In addition, since speech characteristics are not processed based on factors such as a speaker, noise, and channel information, there is a lack of robustness against noise, speaker variations, etc., and a limitation in speech processing performance. As described above, the related art lacks a method of optimizing an interaction between speech data and text data, resulting in an inability to fully employ the benefit of utilizing multimodal data.

### RELATED ART DOCUMENTS

### Patent Documents

Patent Document 1: Korean Patent Publication No. 10-2017-0107283, Sep. 25, 2017 (Korean Patent Registration No. 10-2158743)

### SUMMARY OF THE INVENTION

The present invention is directed to providing a speech recognizer based on shared and exclusive attributes, and a system and method for training the same that are capable of generating a representation learning-based pre-trained model with excellent performance in the field of speech recognition on the basis of a large amount of speech and text data, and performing encoding to enable representation learning of speech-text multi modal information in a single model space.

The technical objectives of the present invention are not limited to the above, and other objectives that are not described above may become apparent to those of ordinary skill in the art based on the following description and the accompanying drawings.

According to the first aspect of the present invention, there is provided a method of training a speech recognizer based on shared and exclusive attributes, the method including: inputting a parallel speech corpus constituting a labeled speech corpus and a non-parallel speech corpus into a speech encoder constituting a speech recognizer; outputting a representation vector representing training speech as an output of the speech encoder; inputting a parallel text corpus constituting the labeled speech corpus and a non-parallel text corpus into a text encoder; outputting a representation vector representing text as an output of the text encoder; and receiving and decoding, by a decoder, each of the representation vectors of the speech encoder and the text encoder.

The outputting of a representation vector representing training speech as the output of the speech encoder may include separately outputting, by the speech encoder, a first representation vector based on shared attributes of speech and text and a second representation vector based on exclusive attributes of only the speech.

The outputting of a representation vector representing training speech as the output of the speech encoder may include separately outputting, by the speech encoder, the first representation vector and the second representation vector through an attribute-separated latent variable inference based on a graph structure that separates attributes varying at a segment level and attributes varying at a sequence level.

The receiving and decoding of, by the decoder, each of the representation vectors of the speech encoder and the text encoder may include: performing an alignment between modalities to learn a relationship between each of the representation vectors of the speech encoder and the text encoder; performing decoding to generate text based on a result of the alignment between the modalities; and outputting the generated text.

The method may further include receiving and fine-tuning the parallel speech corpus and the parallel text corpus constituting the labeled speech corpus.

According to the second aspect of the present invention, there is provided a system for training a speech recognizer based on shared and exclusive attributes, the system including: a communication module that receives a labeled speech corpus, a non-parallel speech corpus, and a non-parallel text corpus; a memory in which a program for training the speech recognizer is stored; and a processor that executes the program stored in the memory to input a parallel speech corpus constituting the labeled speech corpus and the non-parallel speech corpus into a speech encoder constituting the speech recognizer to output a representation vector representing training speech, input a parallel text corpus constituting the labeled speech corpus and the non-parallel text corpus into a text encoder to output a representation vector representing text, and receive and decode, by a decoder, each of the representation vectors of the speech encoder and the text encoder.

The processor may allow the speech encoder to separately output a first representation vector based on shared attributes of speech and text and a second representation vector based on exclusive attributes of only the speech.

The processor may allow the speech encoder to separately output the first representation vector and the second representation vector through an attribute-separated latent variable inference based on a graph structure that separates attributes varying at a segment level and attributes varying at a sequence level.

The processor may be configured to: perform an alignment between modalities to learn a relationship between each of the representation vectors of the speech encoder and the text encoder; perform decoding to generate text based on a result of the alignment between the modalities; and output the generated text.

The processor may receive and fine-tune the parallel speech corpus and the parallel text corpus constituting the labeled speech corpus.

According to the first aspect of the present invention, there is provided a speech recognizer including: a speech encoder that, on the basis of input speech, separately outputs a first representation vector based on shared attributes of speech and text and a second representation vector based on exclusive attributes of only the speech; and a decoder that receives the first representation vector and the second representation vector and outputs recognized text.

The speech encoder may separately output the first representation vector and the second representation vector through an attribute-separated latent variable inference based on a graph structure that separates attributes varying at a segment level and attributes varying at a sequence level.

In order to resolve the above issues, a computer program according to another embodiment of the present invention is stored in a computer-readable recording medium to execute a method of training a speech recognizer based on shared and exclusive attributes in combination with a computer, which is hardware.

Other specific details of the present invention are included in the specification and the accompanying drawings.

### BRIEF DESCRIPTION OF THE DRAWINGS

FIG. 1 is a block diagram illustrating a system for training a speech recognizer according to an embodiment of the present invention.

FIG. 2 is a flowchart showing a method of training a speech recognizer according to an embodiment of the present invention.

FIG. 3 is a diagram for describing a method of training a speech recognizer according to an embodiment of the present invention based on functional blocks.

FIG. 4 is a diagram for describing a speech recognizer according to an embodiment of the present invention.

### DETAILED DESCRIPTION OF EXEMPLARY EMBODIMENTS

Hereinafter, the advantages and features of the present invention and ways of achieving them will become readily apparent with reference to the following embodiments described in detail in conjunction with the accompanying drawings. However, the present invention is not limited to such embodiments and may be embodied in various forms. The embodiments to be described below are provided only to make the disclosure of the present invention complete and assist those of ordinary skill in the art in fully understanding the scope of the present invention, and the scope of the present invention is defined only by the appended claims.

Terms used herein are used for describing the embodiments and are not intended to limit the scope and spirit of the present invention. It should be understood that the singular forms “a” and “an” in addition include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof. In connection with assigning reference numerals to elements in the drawings, the same reference numerals are used for designating the same elements throughout the specification, and the term “and/or” includes any one or combinations of the associated listed items. It should be understood that, although the terms “first,” “second,” etc. may be used herein to describe various elements, these elements are not limited by these terms. These terms are only used for distinguishing one element from another. For example, a first element could be a second element without departing from the scope of the present invention.

Unless otherwise defined, all terms (including technical and scientific terms) used herein have the same meanings as commonly understood by those of ordinary skill in the art to which this invention belongs. It should be further understood that terms, such as those defined in commonly used dictionaries, should not be interpreted in an idealized or overly formal sense unless expressly defined herein specifically.

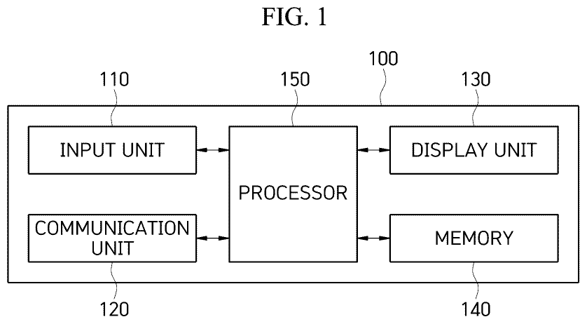

Hereinafter, a system 100 for training a speech recognizer based on shared and exclusive attributes (hereinafter a speech recognizer training system) according to an embodiment of the present invention will be described with reference to FIG. 1.

FIG. 1 is a block diagram illustrating a speech recognizer training system 100 according to the embodiment of the present invention.

The speech recognizer training system 100 according to the embodiment of the present invention includes an input unit 110, a communication unit 120, a display unit 130, a memory 140, and a processor 150.

The input unit 110 generates input data in response to a user input to the speech recognizer training system 100. As an example, the user input may include a user's speech, speech selected by a user, previously collected speech, or speech for text. The input unit 110 includes at least one input device. The input unit 110 includes a keyboard, a key pad, a dome switch, a touch panel, a touch key, a mouse, a menu button, and the like.

The communication unit 120 receives a labeled speech corpus, a non-parallel speech corpus, and a non-parallel text corpus. The communication unit 120 may include both a wired communication module and a wireless communication module. The wired communication module may be implemented as a power line communication device, a telephone line communication device, a home cable (multimedia over coax alliance: MoCA), Ethernet, IEEE1294, an integrated wired home network, or an RS-485 control device. In addition, the wireless communication module may be composed of modules to implement functions such as wireless LAN (WLAN), Bluetooth, High Dynamic Range Wireless Personal Area Network (HDR WPAN), Ultra-Wideband (UWB), ZigBee, Impulse Radio, 60 GHz WPAN, Binary-CDMA, wireless Universal Serial Bus (USB) technology and wireless High Definition Multimedia Interface (HDMI) technology, as well as 5^{th} generation communication (5G), Long Term Evolution-Advanced (LTE-A), LTE, and wireless fidelity (Wi-Fi).

The display unit 130 displays display data according to the operation of the speech recognizer training system 100. The display unit 130 includes a liquid crystal display (LCD), a light emitting diode (LED) display, an organic light emitting diode (OLED) display, a micro electro-mechanical systems (MEMS) display, or an electronic paper display. The display unit 130 in combination with the input unit 110 may be implemented as a touch screen.

The memory 140 stores a program for training a speech recognizer. Here, the memory 140 is generally referred to as a non-volatile storage device that retains stored information even when power is not supplied, or a volatile storage device. Examples of the memory 140 may include NAND flash memories, such as a compact flash (CF) card, a secure digital (SD) card, a memory stick, a solid-state drive (SSD), and a micro SD card; magnetic computer storage devices, such as a hard disk drive (HDD); and an optical disc drive, such as a compact disc read only memory (CD-ROM) or a digital video disc (DVD)-ROM, etc.

The processor 150 may execute software, such as a program, to control at least one other component (e.g., a hardware or software component) of the speech recognizer training system 100 and perform various data processing or calculations.

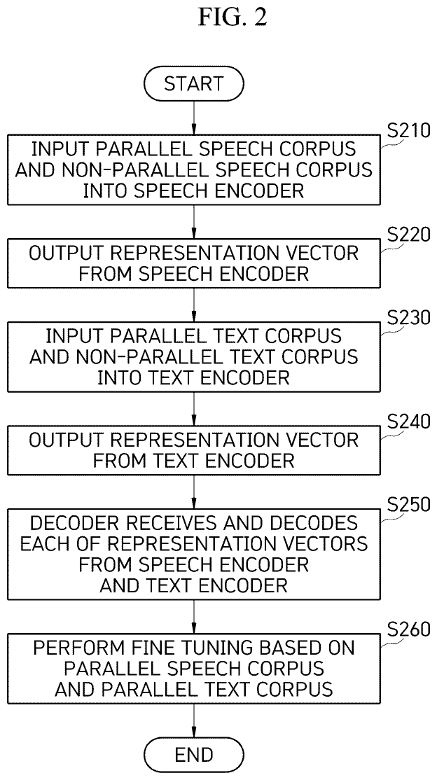

Hereinafter, a method performed by a speech recognizer training system 200 according to an embodiment of the present invention will be described with reference to FIGS. 2 to 4.

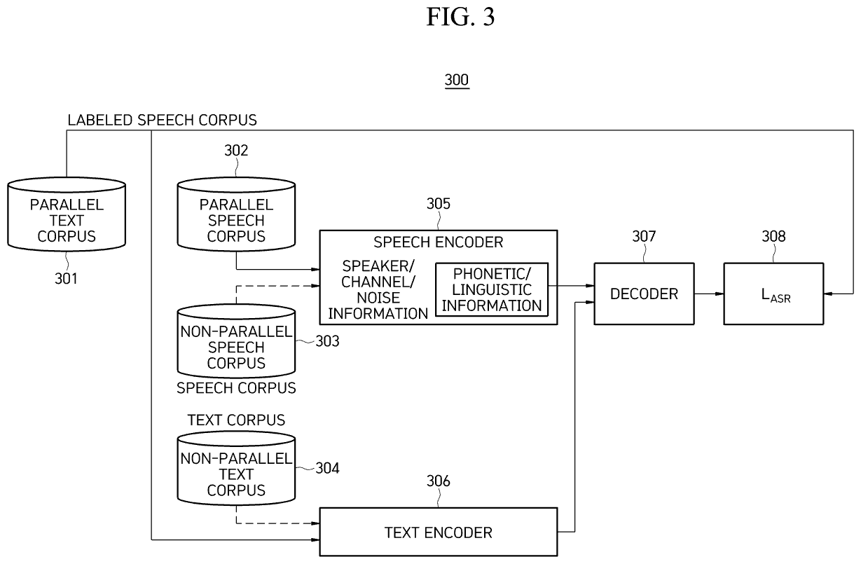

FIG. 2 is a flowchart showing a method of training a speech recognizer according to the embodiment of the present invention. FIG. 3 is a diagram for describing a method of training a speech recognizer according to the embodiment of the present invention based on functional blocks.

First, a parallel speech corpus 302 constituting a labeled speech corpus is input to a speech encoder constituting a speech recognizer, together with a non-parallel speech corpus 303 (S210).

Here, the parallel speech corpus 302 is data that represents a mutual relationship between speech and text, for example, data that is given accurate text transcription of speech recordings or speech files. On the other hand, the non-parallel speech corpus 303 is considered speech data in which there is no direct interaction between speech and text, for example, data that is given no accurate text transcription of speech recording or speech files.

Meanwhile, in one embodiment of the present invention, the labeled speech corpus includes a parallel text corpus 301 and a parallel speech corpus 302 as labeled speech data used for training a speech recognizer. In this case, the parallel text corpus 301 may provide transcription information of speech data based on text data, and the parallel speech corpus 302 may provide a mutual relationship between text and speech.

In one embodiment of the present invention, in addition to the labeled speech corpus, a non-parallel speech corpus 303 and a non-parallel text corpus 304 are used for pre-training.

On the other hand, a text corpus only has simple content information of linguistic/semantic information, while a speech corpus may include not only linguistic/semantic information contained in a text corpus but also phonetic information about a form in which linguistic information is implemented, for example, phonetic characteristic information of the language, such as pronunciation, stress, intonation, pronunciation patterns, and the like of language sounds. In addition, the speech corpus may include additional information, such as a speaker, a channel, and noise.

Such a difference in information between speech and text leads to an issue referred to as information disharmony. This causes a difficulty in modeling speech and text in the same network structure. In other words, the speech corpus includes not only linguistic/semantic information, but also information about pronunciation and phonetic characteristics, and information about a speaker, a channel, and noise, while the text corpus mainly focuses only on linguistic/semantic information. Due to this information disharmony, there is an issue in the existing model structure as to what information is utilized for training and how to utilize information for training.

In order to resolve the issue, an embodiment of the present invention proposes a method of effectively integrating speech and text data and handles information differences in a harmonious manner.

Next, a representation vector representing training speech is output as an output of a speech encoder 305 (S220). In one embodiment, the speech encoder 305 uses the parallel speech corpus 302 and the non-parallel speech corpus 303 as an input and outputs an embedding vector representing training speech. In this case, the speech encoder 305 may separately output a first representation vector based on shared attributes of speech and text and a second representation vector based on exclusive attributes of only the speech.

To this end, the speech encoder 305 may separately output the first representation vector and the second representation vector through an attribute-separated latent variable inference based on a graph structure that separates attributes varying at a segment level and attributes varying at a sequence level. In other words, the speech encoder 305 may process information about a specific part and the entire sequence in input data differently, thereby allowing features of the speech data to be effectively extracted.

Next, a parallel text corpus 301 constituting the labeled speech corpus and a non-parallel text corpus 304 are input to a text encoder 306 (S230), and a representation vector representing text is output as an output of the text encoder 306 (S240).

Here, the parallel text corpus 301 is data that represents a mutual relationship between speech and text, while the non-parallel text corpus 304 includes only text data and provides text information without mutual interaction between speech and text.

Next, each of the representation vectors output from the speech encoder 305 and the text encoder 306 is received and decoded in a decoder 307 (S250).

In one embodiment, the decoder 307 performs a cross modality alignment process to learn the relationship between each of the representation vectors of the speech encoder 305 and the text encoder 306. In this case, the cross-modality alignment process is a learning process performed to combine multimodal information between speech and text and identify the mutual relationship between speech and text.

Additionally, the decoder 307 performs decoding to generate text based on the results of alignment between modalities. That is, the decoder 307 may convert speech into text or output related text information.

In addition, a fine tuning unit LASR 308 according to one embodiment of the present invention may receive and fine-tunes the parallel speech corpus 302 and the parallel text corpus 301, which constitute the labeled speech corpus (S260). As an example, the fine tuning process is a process of training a model (a speech recognizer) on the relationship between speech data and accurate text information corresponding thereto, or adjusting the weights of the model to suit speech-text multi-model tasks.

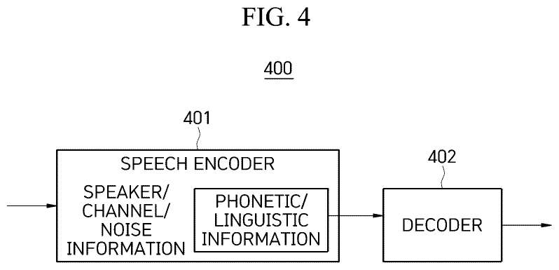

FIG. 4 is a diagram for describing a speech recognizer 400 according to an embodiment of the present invention. Meanwhile, the speech recognizer 400 shown in FIG. 4 may be a speech recognizer trained through the above-described training process, but it is not limited thereto.

The speech recognizer 400 according to the embodiment of the present invention includes a speech encoder 401 and a speech decoder 402.

The speech encoder 401 outputs a representation vector representing input speech. Specifically, the speech encoder 401 may, based on input speech, output a first representation vector based on shared attributes of speech and text, and output a second representation vector based on exclusive attributes of only the speech to be distinguished from the first representation vector.

In this case, the speech encoder 401 may separately output the first representation vector and the second representation vector through an attribute-separated latent variable inference based on a graph structure that separates attributes varying at a segment level and attributes varying at a sequence level.

The decoder 402 receives the first and second representation vectors and outputs recognized text. That is, the decoder 402 receives the first representation vector, which is composed of only content information, through the speech encoder 401 capable of attribute separation, and thus enables speech recognition that is robust to channel, noise, and speaker variations.

Meanwhile, in the above description, operations S210 to S260 may be further segmented into a larger number of operations or combined into a smaller number of operations according to examples of implementation of the present invention. In addition, some of the operations may be omitted or may be executed in the reverse order as needed. Parts omitted in the following description, which have been described above with reference to FIGS. 2 and 3, may be applied to the description shown in FIGS. 1 and 4.

The method of training a speech recognizer based on shared and exclusive attributes according to the embodiment of the present invention described above may be implemented as a program (or an application) to be executed in combination with a computer, which is hardware, and stored in a medium.

The program may include codes coded in a computer language, such as C, C++, Java, Ruby, another machine language, etc., that can be read by a processor (e.g., a CPU) of a computer through a device interface of the computer in order for the computer to read the program and execute the methods implemented as the program. The code may include a functional code that is related to a function that defines functions needed to execute the methods and may include an execution-procedure-related control code needed to cause the processor of the computer to execute the functions according to a predetermined procedure. In addition, the code may further include a memory-reference-related code indicating whether additional information or media needed to cause the processor of the computer to execute the functions should be referred to at a location (an address) of an internal or external memory of the computer. In addition, when the processor of the computer needs to communicate with any other computers or servers, etc. at a remote site, to perform the above-described functions, the code may further include communication-related codes such as those indicating how to communicate with any other computers or servers at a remote site and what information or media should be transmitted or received during communication.

The storage medium is not a medium that stores data for a short period of time, such as a register, cache, memory, etc., but is a medium that stores data semi-permanently and can be read by a device. Specifically, examples of the storage medium include may include a ROM, a RAM, a CD-ROM, a magnetic tape, a floppy disk, an optical data storage device, etc., but the storage medium is not limited thereto. That is, the program may be stored in various recording media on various servers which the computer can access or on various recording media on the computer of the user. In addition, the medium may be distributed over computer systems connected through a network so that computer-readable codes may be stored in a distributed manner.

The above description of the invention is for illustrative purposes, and a person having ordinary skill in the art should appreciate that other specific modifications can be easily made without departing from the technical spirit or essential features of the invention. Therefore, the above-described embodiments should be regarded as illustrative rather than limitative in all aspects. For example, components which have been each described as being a single unit can be embodied in a distributed form, whereas components which have been described as being distributed can be embodied in a combined form.

As is apparent from the above, according to the embodiment of the present invention, information mismatch occurring in the existing speech-text multimodal model can be resolved, thereby enabling effective interaction and information sharing between speech data and text data. In addition, the embodiment of the present invention can enable learning of accurate speech-text relationships by utilizing a parallel text corpus and a parallel speech corpus and improve the performance of speech recognizers for speech recognition and multimodal tasks through a fine tuning process.

The embodiment of the present invention can be used in speech recognition, speech synthesis, natural language understanding, multimodal conversation systems, speech search, and various speech-to-text related applications, and also used to construct a better speech-to-text model such that multimodal speech-to-text tasks are performable.

The effects of the present invention are not limited to the above-described effects, and other effects that are not described will be clearly understood by those skilled in the art from the following description.

The scope of the present invention is not defined by the detailed description as set forth above but by the accompanying claims of the invention. It should also be understood that all changes or modifications derived from the definitions and scope of the claims and their equivalents fall within the scope of the invention.

What is claimed is:

1. A method of training a speech recognizer based on shared and exclusive attributes, which is a method performed by a computer, the method comprising:
inputting a parallel speech corpus constituting a labeled speech corpus and a non-parallel speech corpus into a speech encoder constituting a speech recognizer;
outputting a representation vector representing training speech as an output of the speech encoder;
inputting a parallel text corpus constituting the labeled speech corpus and a non-parallel text corpus into a text encoder;
outputting a representation vector representing text as an output of the text encoder; and
receiving and decoding, by a decoder, each of the representation vectors of the speech encoder and the text encoder.

2. The method of claim 1, wherein the outputting of a representation vector representing training speech as the output of the speech encoder includes separately outputting, by the speech encoder, a first representation vector based on shared attributes of speech and text and a second representation vector based on exclusive attributes of only the speech.

3. The method of claim 2, wherein the outputting of a representation vector representing training speech as the output of the speech encoder includes separately outputting, by the speech encoder, the first representation vector and the second representation vector through an attribute-separated latent variable inference based on a graph structure that separates attributes varying at a segment level and attributes varying at a sequence level.

4. The method of claim 1, wherein the receiving and decoding of, by the decoder, each of the representation vectors of the speech encoder and the text encoder includes:
performing an alignment between modalities to learn a relationship between each of the representation vectors of the speech encoder and the text encoder;
performing decoding to generate text based on a result of the alignment between the modalities; and
outputting the generated text.

5. The method of claim 1, further comprising receiving and fine-tuning the parallel speech corpus and the parallel text corpus constituting the labeled speech corpus.

6. A system for training a speech recognizer based on shared and exclusive attributes, the system comprising:
a communication module that receives a labeled speech corpus, a non-parallel speech corpus, and a non-parallel text corpus;
a memory in which a program for training the speech recognizer is stored; and
a processor that executes the program stored in the memory to:
input a parallel speech corpus constituting the labeled speech corpus and the non-parallel speech corpus into a speech encoder constituting the speech recognizer to output a representation vector representing training speech;
input a parallel text corpus constituting the labeled speech corpus and the non-parallel text corpus into a text encoder to output a representation vector representing text; and
receive and decode, by a decoder, each of the representation vectors of the speech encoder and the text encoder.

7. The system of claim 6, wherein the processor allows the speech encoder to separately output a first representation vector based on shared attributes of speech and text and a second representation vector based on exclusive attributes of only the speech.

8. The system of claim 7, wherein the processor allows the speech encoder to separately output the first representation vector and the second representation vector through an attribute-separated latent variable inference based on a graph structure that separates attributes varying at a segment level and attributes varying at a sequence level.

9. The system of claim 6, wherein the processor is configured to:
perform an alignment between modalities to learn a relationship between each of the representation vectors of the speech encoder and the text encoder;
perform decoding to generate text based on a result of the alignment between the modalities; and
output the generated text.

10. The system of claim 6, wherein the processor receives and fine-tunes the parallel speech corpus and the parallel text corpus constituting the labeled speech corpus.

11. A speech recognizer comprising:
a speech encoder that, on the basis of input speech, separately outputs a first representation vector based on shared attributes of speech and text and a second representation vector based on exclusive attributes of only the speech; and
a decoder that receives the first representation vector and the second representation vector and outputs recognized text.

12. The speech recognizer of claim 11, wherein the speech encoder separately outputs the first representation vector and the second representation vector through an attribute-separated latent variable inference based on a graph structure that separates attributes varying at a segment level and attributes varying at a sequence level.
